(19) United States
(12) Patent Application Publication
(10) Pub. No.: US 2005/0234973 A1
(43) Pub. Date: Oct. 20, 2005

(54) Mining service requests for product support

(75) Inventors: Hua-Jun Zeng, Beijing (CN); Benyu Zhang, Beijing (CN); Zheng Chen, Beijing (CN); Ji-Rong Wen, Beijing (CN); Hang Li, Beijing (CN); Wei-Ying Ma, Beijing (CN); Gabor Hirschler, Issaquah, WA (US); Kurt Samuelson, Issaquah, WA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/826,160

(22) Filed: Apr. 15, 2004

(51) Int. Cl. G06F 17/30

(52) U.S. Cl. 707/103 R

(57) ABSTRACT

Systems and methods for mining service requests for product support are described. In one aspect, unstructured service requests are converted to one or more structured answer objects. Each structured answer object includes hierarchically structured historic problem diagnosis data. In view of a product problem description, a set of the one or more structured answer data objects is identified. Each structured solution data object in the set includes term(s) and/or phrase(s) related to the product problem description. Historic and hierarchically structured problem diagnosis data from the set is provided to an end-user for product problem diagnosis.

### RELATED APPLICATIONS

This patent application is related to the following patent applications, each of which are commonly assigned to assignee of this application, and hereby incorporated by reference:
U.S. patent application Ser. No. 10/427,548, titled “Object Clustering Using Inter-Layer Links”, filed on May 1, 2003; and
U.S. patent application Ser. No. <to be assigned>, titled “Reinforced Clustering of Multi-Type Data Objects for Search Term Suggestion”, filed on Apr. 15, 2004.

### TECHNICAL FIELD

Systems and methods of the invention pertain to data mining.

### BACKGROUND

Today's high technology corporations typically provide some aspect of product support to ensure that consumers and partners receive the maximum value on technology investments. For instance, a variety of consumer and business support offerings and strategic IT consulting services may be provided to help meet various needs of customers and partners. Support offerings may include phone, on-site, Web-based support, and so on. Unfortunately, such product support services can become prohibitively expensive, not only in terms of financial costs, but also the amount of time required to find a solution to a problem experienced by an end-user. For instance, onsite support offering are typically expensive to the extent that non-corporate consumers may not be able to afford to hire an individual product consultant or troubleshooter.

Additionally, when services are automated (for instance, via online searches of a knowledge base comprising product help (how to) and/or troubleshooting articles) the amount of time that it may take the consumer to identify an on-point set of articles may become prohibitive. One reason for this is because knowledge base articles are typically generated by professional writers, vendors, and/or the like, and not the everyday users of the products for which support is sought. In such a scenario, if a user does not form a search query using the exact terminology adopted by the author of an on-point KB article, the user may find it very difficult and time consuming to locate any on-point knowledge base troubleshooting information. To make matters worse, KB articles are in general specific to one particular problem with one specific cause, that is, there is a lack of comprehensive documentation for multiple problem probing and diagnosis. Thus, the user may be required to locate and review many KB articles to come to a solution for a problem that has many potential causes.

### SUMMARY

Systems and methods for mining service requests for product support are described. In one aspect, unstructured service requests are converted to one or more structured answer objects. Each structured answer object includes hierarchically structured historic problem diagnosis data. In view of a product problem description, a set of the one or more structured answer data objects is identified. Each structured solution data object in the set includes keyword(s) and/or keyphrase(s) related to the product problem description. Historic and hierarchically structured problem diagnosis data from the set is provided to an end-user for product problem diagnosis.

### BRIEF DESCRIPTION OF THE DRAWINGS

In the figures, the left-most digit of a component reference number identifies the particular figure in which the component first appears.

FIG. 1 illustrates an exemplary system for mining service requests for product support.

FIG. 2 shows an exemplary troubleshooting wizard user interface to present hierarchically structured historical problem diagnosis data from structured answer object(s) to a user for selective product problem diagnoses interaction.

FIG. 3 illustrates an exemplary procedure 300 for a product support service server to mine service requests for product support.

FIG. 4 illustrates an exemplary procedure for a client computing device to present structured answer objects in a troubleshooting wizard to provide an end-user with product problem support.

FIG. 5 shows an exemplary suitable computing environment on which the subsequently described systems, apparatuses and methods for mining service requests for product support may be fully or partially implemented.

FIG. 6 is a block diagram of one embodiment of computer environment that can be used for clustering.

FIG. 7 is a block diagram of one embodiment of a framework for clustering heterogeneous objects.

FIG. 8 is a block diagram of one embodiment of hybrid net model.

FIG. 9 is a block diagram of another embodiment of computer environment that is directed to the Internet.

FIG. 10 is a flow chart of one embodiment of clustering algorithm.

FIG. 11 is a flow chart of one embodiment of clustering algorithm.

FIG. 12 is a block diagram of another embodiment of a framework for clustering heterogeneous objects that includes a hidden layer.

FIG. 13 is a flow chart of another embodiment of clustering algorithm.

### DETAILED DESCRIPTION

Overview

Knowledge Base (KB) and help (“how-to”) articles are created to assist customers in locating a solution to solve/troubleshoot a product problem. Studies have shown that the easier it is for an end-user to search for and obtain an on-point KB article (i.e., one that directly addresses the customer's inquiry), the greater will be the customer's satisfaction with the product and its support infrastructure. However, research has shown that end-users often spend a significant amount of time collecting data, such as KB article(s), attempting to locate on-point articles to their troubleshooting inquiries. One reason for this is because conventional product support infrastructures often deal with single cause problems, but lack multiple cause product problem diagnosis knowledge representations. To address this limitation, the following systems and methods mine, analyze, and organize unstructured product support service (PSS) log service requests for product support based on interrelated clusters of structured data objects. The structured data objects include historical single and multiple product problem diagnosis data.

In particular, user generated context and links/references to product support (PS) articles are extracted from a PSS log of unstructured service requests. The extracted information is textually analyzed and organized into clusters of interrelated structured data objects according to feature relevance. For instance, link information may be relatively spare as compared to other service request content. However, when two service requests cite a same KB article, it is probable that the two service requests correspond to the same problem and cause. After analysis and clustering, the structured objects include some combination of product problem symptoms, causes, resolutions, links/citations to related PS documents, and references to any other related data objects. These clusters of hierarchically structured data objects are used to generate the troubleshooting wizard.

The troubleshooting wizard, in view of a symptom or problem description for a given product, provides a user with directed organized interaction with the structured data objects for problem diagnosis and resolution. In particular, the troubleshooting wizard allows end-users to systematically leverage the hierarchically structured historical data objects to match/identify their product problem symptom, or description, with corresponding problem cause(s) and resolution(s). These and other aspects of the systems and methods to mine service requests for product support are now described in greater detail.

An Exemplary System

Turning to the drawings, wherein like reference numerals refer to like elements, the systems and methods are described and shown as being implemented in a suitable computing environment. Although not required, the invention is described in the general context of computer-executable instructions, such as program modules, being executed by a personal computer. Program modules generally include routines, programs, objects, components, data structures, etc., that perform particular tasks or implement particular abstract data types. While the systems and methods are described in the foregoing context, acts and operations described hereinafter may also be implemented in hardware.

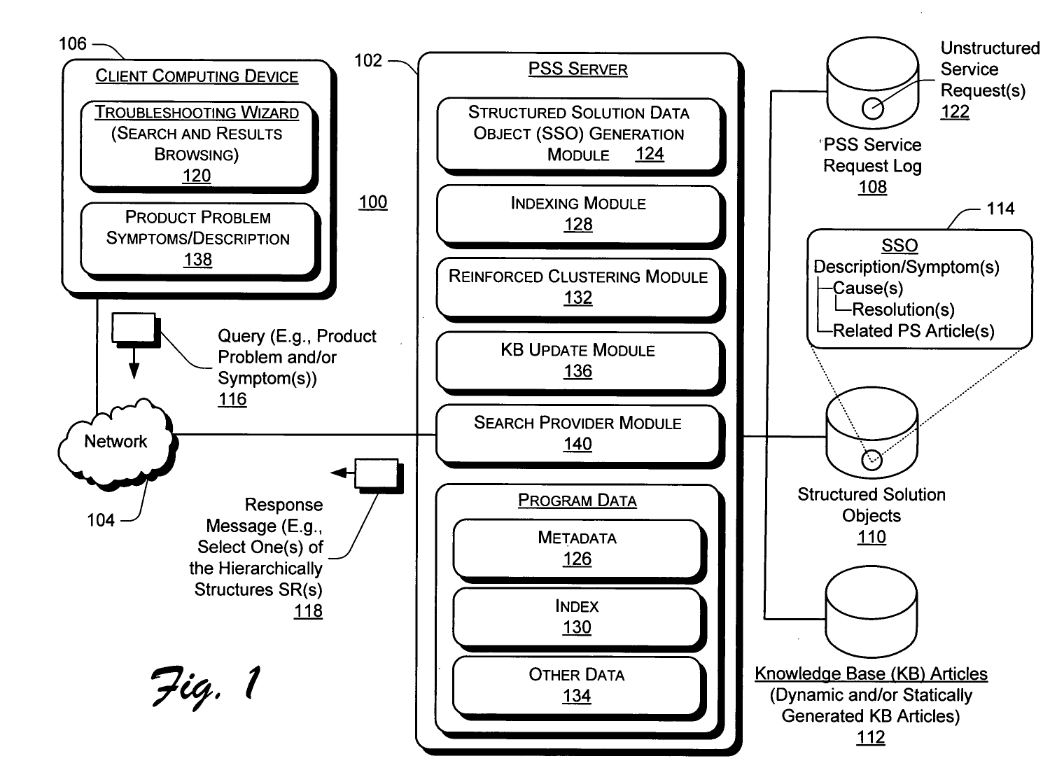

FIG. 1 shows an exemplary system 100 for mining service requests for product support. In this implementation, system 100 includes product support service (PSS) server 102 coupled across a communications network 104 to client computing device 106. Network 104 may include any combination of a local area network (LAN) and a general wide area network (WAN) communication environments, such as those which are commonplace in offices, enterprise-wide computer networks, intranets, and the Internet. PSS server 102 is coupled to the following data repositories: PSS service request (SR) log 108, clustered and hierarchically structured answer data objects 110, and KB article(s) 112. Client computing device 106 is any type of computing device such as a personal computer, a laptop, a server, a mobile computing device (e.g., a cellular phone, personal digital assistant, or handheld computer), etc.

PSS server 102 mines PSS service request log 108 to generate clusters of hierarchically organized and structured answer data objects (SAOs) 110. Each SAO 110 includes historical, single and/or multiple problem, product problem diagnosis data. Such diagnosis data is organized by PSS server 102 into a hierarchical tree as a function of one or more of problem description/symptom(s), result(s), causes(s), and resolution(s) diagnosis data, for example as shown in callout 114. As described below, responsive to receipt by the PSS server of a problem description/symptom query 116 from the client computing device 106, respective ones of these structured answer data objects 110 are sent in a response message 118 by the PSS server 102 to the client computing device 106. The structured answer data objects 110 communicated to the client computing device 106 correspond to terms of the query 116. An end-user client of computing device 106 uses troubleshooting wizard 120 to systematically present and leverage the historical product problem diagnosis data encapsulated by the communicated structured answer data objects 110 to identify at least the problem's corresponding cause(s) and associated resolution(s). Prior to describing how troubleshooting wizard 120 presents such hierarchically structured historical product problem diagnosis data to an end-user for problem resolution, we first describe how structured answer data objects 110 are generated in the by the PSS server 102.

### Structured Answer Data Objects

Each entry logged in PSS service request log 108 is the result of end-user and product support engineer/staff product problem diagnosis, troubleshooting, and resolution probing communication processes. Such product problem diagnosis and resolution communications are informal (i.e., not based on information solely generated by a professional writer or vendor tasked with documenting a product), and often include a set of unstructured questions and answers directed to narrowing down product problem symptom to a root cause. The questions may include some combination of product name, problem context such as problem description, symptoms, causes, resolution(s), and/or the like. Support engineer/staff responses may include some combination of relevant system and product problem diagnosis/probing questions, a cause, and/or a solution to the problem. The support/staff responses may also include links/references to PS articles (e.g., knowledge base (KB) article(s) 112) that are relevant to the particular problem resolution process. Such links/references often include, for example, substantially unique document IDs, hypertext links, Universal Resource Identifiers (URIs), document titles, and/or so on. These informal communications between the end-user and product support engineer(s)/staff are hereinafter referred to as unstructured service requests 122.

To mine the PSS service request log 108, structured answer object (SAO) generation module 124 extracts product problem context and resolution information from respective ones of the unstructured service requests 122. Such extracted information in its intermediate data format is shown as metadata 126, and includes for example, any combination of product name, problem context such as problem description, symptoms, causes, resolution(s), product problem diagnosis/probing questions, cause(s), solution(s), link(s)/reference(s) data to one or more PS articles, and/or the like. SAO generation module 124 aligns related symptom(s), results(s), cause(s), resolution(s), question/answer pairs, related KB articles, and so on, from the metadata 126 to form structured answer objects 110. A single SAO 110 is generated from a single service request, so an SAO 110 represents a one-problem-one-cause-one-solution structure. A hierarchical one-problem-to-multiple-cause-multiple-solution is provided by clustering multiple SAOs 110 together, as described below in paragraphs [0022], [0023], and [0024].

To facilitate search and retrieval across SAOs 110 in view of a set of problem description terms, indexing module 128 creates index 130. To this end, indexing module 128 extracts terms and keyphrases from SAOs 110, performs statistical and session-based feature selection to assign appropriate weight to extracted features, and normalizes terminology within the SAOs 110. In particular, a feature extraction portion of indexing module 128 performs extracts features such as terms, phrases, and/or sentences from the structured answer objects 110. Statistical information is used to perform this extraction. For instance, in one implementation, if a word appears many times in a first document (SAO) and appears little or not at all in a second (different) document, then the particular word is determined to be a term in the first document. Mutual information is used to calculate keyphrases. For example, when two terms frequently appear adjacent with respect to one-another in a document, then the two terms are combined to generate a phrase. Such extracted term and phrase features are represented with a respective portion of index 130. In one implementation, indexing module 128 augments one or more of the extracted features with semantic data such as with synonyms.

Next, indexing module 128 performs statistical and session based selection (feature selection) of the extracted features to select and assign high weights to the substantially most important tokens. Statistical feature selection treats a document as a flat structure, i.e. a bag of words, to perform simple term statistics such as term frequency. Session-based feature selection utilizes the internal structure of the service requests. For example, service requests can be seen as a tree structure of multiple messages, with each node being the reply message of its parent node. This tree structure is used to enhance feature selection. Feature selection operation results are represented with a respective portion of index 130. Exemplary feature selection algorithm(s) is/are based on DF, IG, MI, CHI, with a focus on aggressive dimensionality reduction, as described, for example, in “A Comparative Study on Feature Selection in Text Categorization”, Yang and Pederson, 1997.

Next, indexing module 128 transforms, or normalizes the extracted features. Such normalization converts terms to a consistent format for instance between engineers and between customers and engineers. For example, in one implementation, the term “corrupt” may be mapped as being similar to the term “damaged”, the term “WINDOWS XP” mapped to the term “Win XP”, and/or the like. Term normalization is described, for example, in “Building a Web Thesaurus from Web Link Structure”, SIGIR-03, July-August 2003, which is hereby incorporated by reference. Results of term normalization are represented with a respective portion of index 130.

### A Unified Framework for SAO 110 Classifications and Clustering

Reinforced clustering module 132, using information from index 130, organizes the SAOs 110 into semantic clusters based on their content and link features. For instance, although link information may be relatively sparse as compared to other SAO content, when multiple SAOs 110 cite a same KB article 112, it is probable that the multiple SAOs 110 correspond to a same problem and cause. In this scenario, reinforced clustering module 132 cross references the multiple SAOs 110 as being related. In particular, reinforced clustering module 132 calculates similarity of SAO 110 (document/object) pairs using a mutual reinforcement clustering algorithm to iteratively cluster each SAO's features to a lower dimensional feature space. SAO 110 similarity calculations are based on tf*idf, which is a well-known weighting algorithm that normalizes term/feature weights. Exemplary techniques for reinforced clustering are described “Reinforcement Clustering of Multi-Type Interrelated Data Objects”, as described below in Appendix A. After analysis and clustering of related SAOs 110, related SAOs 110 are clustered together into troubleshooting wizard 120, as described below, and the indexes are stored in index 130.

Semi-supervised learning methods construct classifiers using both labeled and unlabeled training data samples. While unlabeled data samples can help to improve the accuracy of trained models to certain extent, existing methods still face difficulties when labeled data is not sufficient and biased against the underlying data distribution. To address this limitation of conventional clustering methods, in one implementation, clustering module 132 unifies its reinforced clustering operations with additional clustering analysis, such as that generated by a human being. This forms a unified framework for clustering and classification of SAOs 110.

For instance, in one implementation, clustering based classification (CBC) operations of the reinforced clustering module 132 first clusters training data, including both the labeled and unlabeled data with the guidance of the labeled data. Some of unlabeled data samples are then labeled based on the clusters obtained. Discriminative classifiers are then subsequently trained with the expanded labeled dataset. For purposes of illustration, such training samples, expanded label dataset(s), clusters, and so on, are represented by respective portions of other data 134. Exemplary techniques for using CBC to perform such unified clustering are described by “CBC: Clustering Based Text Classification Requiring Minimal Labeled Data”, by Hua-Jun Zeng et al., Nov. 19-22, 2003, ICDM-03 (2003 IEEE International Conference on Data Mining), Melbourne, Fla., USA, which is hereby incorporated by reference.

Exemplary Knowledge Base Updating

In one implementation, knowledge base (KB) update module 136 dynamically generates a KB article 112 from one or more SAOs 110. A statically generated KB article is one that is manually generated, for example, by a human being. A dynamically generated KB article 112 is one that is automatically generated by KB update module 136 and comprises information from the corresponding one(s) of the SAOs 110—hierarchically structured historical problem diagnosis data compiled by SAO generation module 124 from product end-user(s) and support engineers/staff. When multiple SAOs 110 are used to generate a KB article, the multiple SAOs 110 represent a reinforced cluster of SAOs 110—as indicated by index 130.

More particularly, SAOs 110 are grouped together to generate troubleshooting wizard 120 when they have the same problem description, as described above in paragraphs [0031], [0032], and [0033]. The frequency of this clustering is the count of SAOs 110 grouped into the troubleshooting wizard 120. Additionally, SAOs 110 with same causes are further clustered into sub-groups, with the frequency of each sub-group being the count of SAOs 110 clustered into the respective subgroup. If the size of the “wizard” (i.e., the set of SAO's used to generate the troubleshooting wizard 120) is large enough, i.e. the frequency of the whole wizard and the frequencies of all sub-group exceed a certain threshold, a new (enhanced) KB article 112 is created.

### An Exemplary Product Problem Troubleshooting Wizard

In this implementation, client computing device 106 includes troubleshooting wizard 120 to allow an end-user of the client computer 106 to systematically present and leverage hierarchically structured historical product problem diagnosis data from structured answer data objects 110 in view of a given product problem symptom or description. Such presentation allows the end-user to identify a problem's corresponding cause(s) and associated resolution(s). To these ends, a user inputs a text-based symptom or problem description 138 for a computer-program application, or product (e.g., browser, word processing application, and/or any other type of computer programming application) into troubleshooting wizard 120 (e.g., via a user interface (UI) control). Troubleshooting wizard 120 generates query 116 comprising a product problem description and/or symptom(s) 138, and communicates query 116 to search provider module 140 of the PSS server 102 over network 104.

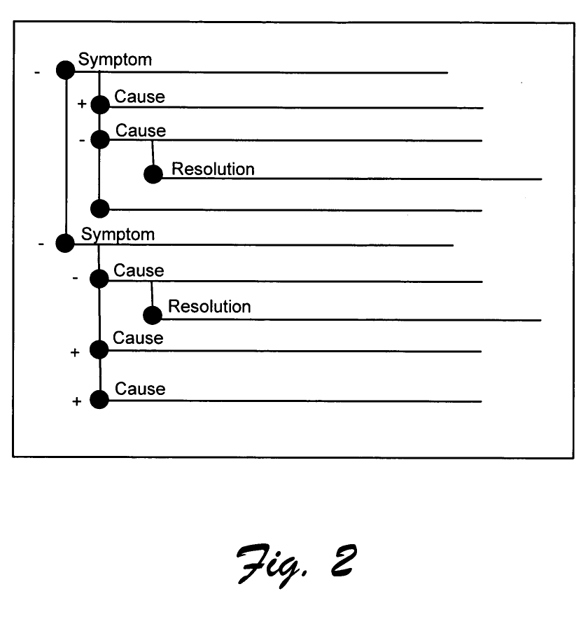

Responsive to receiving query 116, search provider 140 performs a full-text search of index 130 to identify one or more SAOs 110 for terms and/or phrases associated with term(s) in query 116. In one implementation, such term(s) and/or phrase(s) will have a substantially high objective relevance (weighting) to a query term, and may be used to determine that one SAO 110 is more relevant to the query 116 than another SAO 110. Responsive to locating one or more relevant SAOs 110, search provider 140 communicates the one or more SAOs 110 back to the client computing device 106, for example, via response message 118. Responsive to receiving the one or more SAOs 110, troubleshooting wizard 120 extracts the historical, single and/or multiple problem product problem diagnosis data from the one or more SAOs 110. Troubleshooting wizard 120 presents this extracted information to the end-user of the client computing device 106, for example, as shown in FIG. 2.

FIG. 2 shows an exemplary troubleshooting wizard user interface (UI) 200 to present hierarchically structured historical problem diagnosis data from SAOs 110 to a user for selective product problem diagnoses interaction. As shown in UI 200, for a given product problem symptom/description 138, UI 200 presents one or more corresponding symptoms, causes, resolutions, and/or other information, each of which have been extracted from one or more SAOs 110 encapsulated by response message 118. KB articles 112 related to a symptom are an aggregation of the related KB articles of its sub-cause/resolution, with frequencies being summed up.

Although UI 200 shows a certain number of symptom, cause, and/or resolution data sets, there can be any number of such data as a function of the particular problem 138 being addressed and the content of the SAOs 110. The troubleshooting wizard 120 leverages the internal data representation of the SAO(s) 110 embedded in response 118 to present each symptom, cause, and resolution data set in a respective hierarchical tree structure. In this tree, each symptom parent node has one or more cause child nodes. Each cause node, in turn, is a parent node for one or more resolution child nodes. For purposes of selective presentation of the information in UI 200, in this implementation, “+” and “−” punctuation marks are shown to the left of respective symptom and cause nodes. The “+” and “−” marks represent selectable UI objects allowing a user to selectively expand and/or collapse information associated with the corresponding structured answer object nodes.

The troubleshooting wizard 120, in view of a symptom or problem description 138 for a given product, provides a user via UI 200 with directed organized interaction with the historical problem diagnosis data from the response 118 for problem diagnosis and resolution. Thus, troubleshooting wizard 120 allows end-users to systematically leverage the hierarchically structured historical data objects to match/identify their product problem symptom, or description, with corresponding problem cause(s) and resolution(s).

An Exemplary Procedure

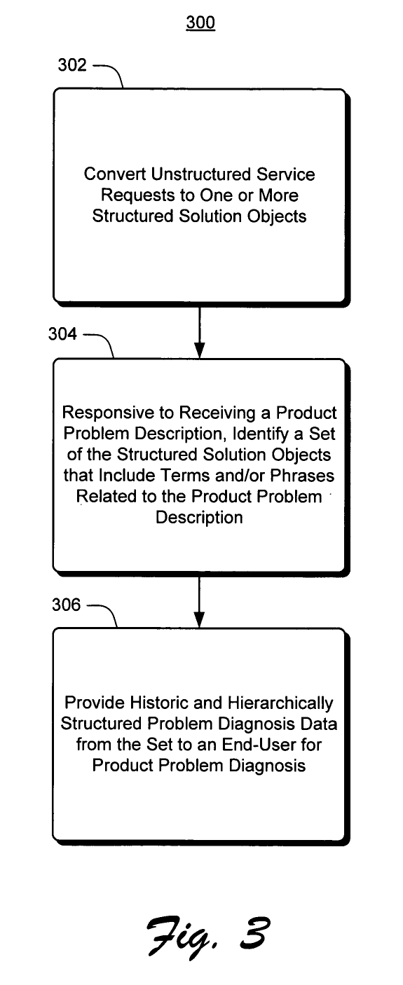

FIG. 3 illustrates an exemplary procedure 300 for a product support service server to mine service requests for product support. For purposes of discussion, operations of the procedure are discussed in relation to the components of FIG. 1. (All reference numbers begin with the number of the drawing in which the component is first introduced). At block 302, product support service (PSS) server 102 (FIG. 1) converts unstructured service requests 122 from PSS service requests log 108 into one or more structured answer objects 110. At block 304, PSS server 102, responsive to receiving a product problem description 138 in a request message 116, identifies a set of the structured answer objects 110 that includes terms and/or phrases related to the product problem description 138. At block 306, PSS server 102 provides historic and hierarchically structured problem diagnosis data from the set to an end-user for product problem diagnosis. In one implementation, this is accomplished by communicating response message 118 to client computing device 106. In another implementation, this is performed by knowledge base update module 136, which dynamically generates a knowledge base article 112 from information in the set.

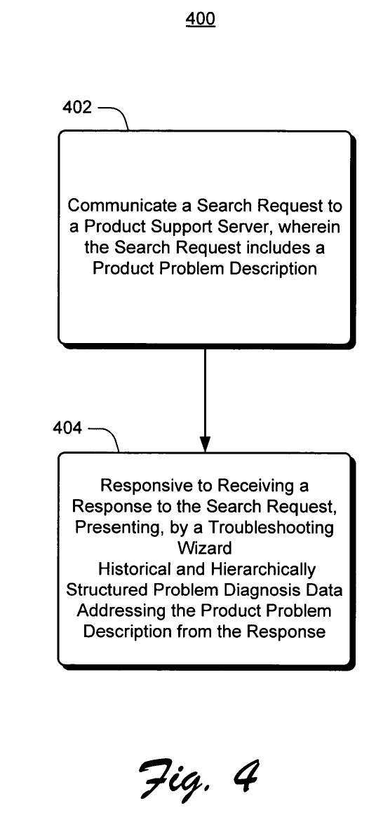

FIG. 4 illustrates an exemplary procedure 400 for a client computing device to present structured answer objects in a troubleshooting wizard to provide an end-user with product support. For purposes of discussion, operations of the procedure are discussed in relation to the components of FIG. 1. (All reference numbers begin with the number of the drawing in which the component is first introduced). At block 402, client computing device 106 communicates a search request (query 116 of FIG. 1) to PSS server 102. The search request includes a product problem description 138. At block 404, responsive receiving a response message 118 to the search request, the client computing device 106 presents a troubleshooting wizard 120 to present historical and hierarchically structured problem diagnosis data addressing the product problem description 138. An exemplary presentation is shown in FIG. 2.

An Exemplary Operating Environment

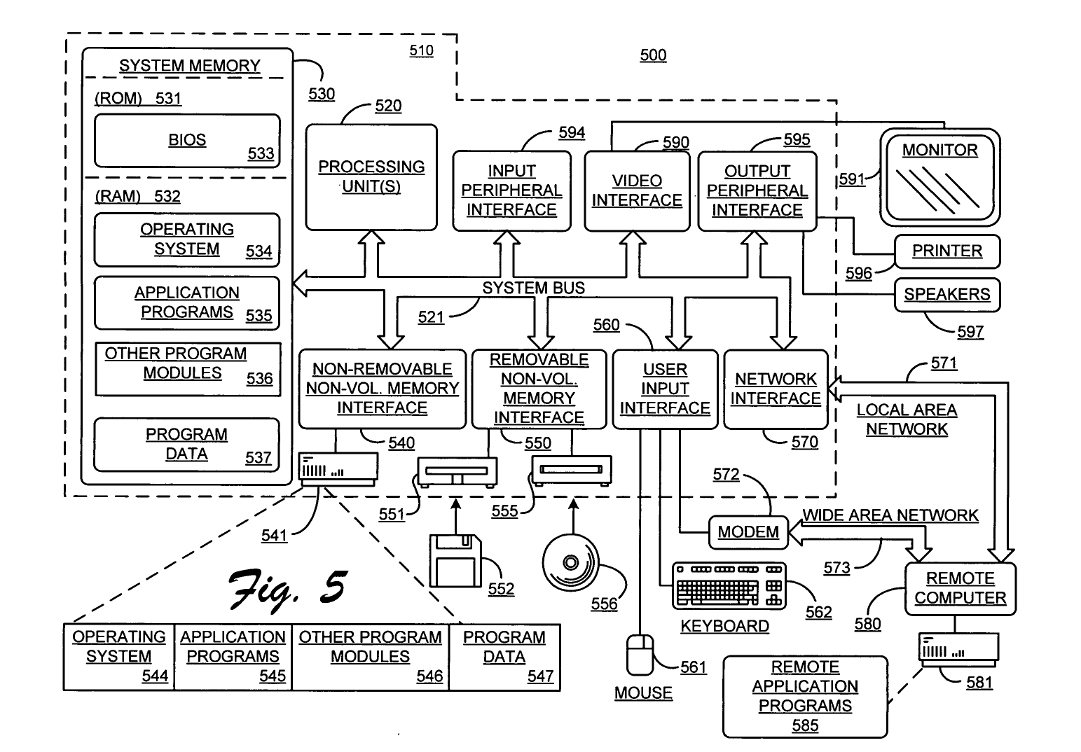

FIG. 5 illustrates an example of a suitable computing environment 500 on which the system 100 of FIG. 1 and the methodology of FIGS. 3 and 4 for mining service requests for product support may be fully or partially implemented. Exemplary computing environment 500 is only one example of a suitable computing environment and is not intended to suggest any limitation as to the scope of use or functionality of systems and methods the described herein. Neither should computing environment 500 be interpreted as having any dependency or requirement relating to any one or combination of components illustrated in computing environment 500.

The methods and systems described herein are operational with numerous other general purpose or special purpose computing system environments or configurations. Examples of well-known computing systems, environments, and/or configurations that may be suitable for use include, but are not limited to, personal computers, server computers, multiprocessor systems, microprocessor-based systems, network PCs, minicomputers, mainframe computers, distributed computing environments that include any of the above systems or devices, and so on. Compact or subset versions of the framework may also be implemented in clients of limited resources, such as handheld computers, or other computing devices. The invention is practiced in a distributed computing environment where tasks are performed by remote processing devices that are linked through a communications network. In a distributed computing environment, program modules may be located in both local and remote memory storage devices.

With reference to FIG. 5, an exemplary system for mining service requests for product support includes a general purpose computing device in the form of a computer 510. The following described aspects of computer 510 are exemplary implementations of client computing device PSS server 102 (FIG. 1) and/or client computing device 106. Components of computer 510 may include, but are not limited to, processing unit(s) 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example and not limitation, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

A computer 510 typically includes a variety of computer-readable media. Computer-readable media can be any available media that can be accessed by computer 510 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 510.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example and not limitation, communication media includes wired media such as a wired network or direct-wired connection, and wireless media such as acoustic, RF, infrared and other wireless media. Combinations of the any of the above should also be included within the scope of computer-readable media.

System memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537. In one implementation, wherein computer 510 is a PSS server 102. In this scenario, application programs 535 comprise structured solution data object generation module 124, reinforced clustering module 132, indexing module 128, search provider module 140, and knowledge base (KB) update module 136. In this same scenario, program data 537 comprises metadata 126, index 130, other data 134, and response message 118. In another implementation, wherein computer 510 is a client computing device 106 of FIG. 1, application programs 535 comprise troubleshooting wizard 120. In this same scenario, program data 537 comprises query 116, and product problem symptoms/description 138.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that they are at least different copies.

A user may enter commands and information into the computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus 521, but may be connected by other interface and bus structures, such as a parallel port, game port or a universal serial bus (USB).

A monitor 591 or other type of display device is also connected to the system bus 521 via an interface, such as a video interface 590. In addition to the monitor, computers may also include other peripheral output devices such as speakers 597 and printer 596, which may be connected through an output peripheral interface 595.

The computer 510 operates in a networked environment using logical connections to one or more remote computers, such as a remote computer 580. The remote computer 580 may be a personal computer, a server, a router, a network PC, a peer device or other common network node, and as a function of its particular implementation, may include many or all of the elements described above relative to the computer 510, although only a memory storage device 581 has been illustrated in FIG. 5. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example and not limitation, FIG. 5 illustrates remote application programs 585 as residing on memory device 581. The network connections shown are exemplary and other means of establishing a communications link between the computers may be used.

Conclusion

Although the systems and methods for mining service requests for product support have been described in language specific to structural features and/or methodological operations or actions, it is understood that the implementations defined in the appended claims are not necessarily limited to the specific features or actions described. For instance, although troubleshooting wizard 120 of FIG. 1 has been shown as being associated with client computing device 106, troubleshooting wizard 120 could also be implemented on the server computer 102. Accordingly, the specific features and actions are disclosed as exemplary forms of implementing the claimed subject matter.

### Appendix A

Background for Exemplary Clustering Systems and Methods

Clustering involves grouping of multiple objects, and is used in such applications as search engines and information mining. Clustering algorithms group objects based on the similarities of the objects. For instance, Web page objects are clustered based on their content, link structure, or their user access logs. The clustering of users is based on the items they have selected. User objects are clustered based on their access history. Clustering of items associated with the users is traditionally based on the users who selected those items. A variety of clustering algorithms are known. Prior-art clustering algorithms include partitioning-based clustering, hierarchical clustering, and density-based clustering.

The content of users' accessed Web pages or access patterns are often used to build user profiles to cluster Web users. Traditional clustering techniques are then employed. In collaborative filtering, clustering is also used to group users or items for better recommendation/prediction.

Use of these prior clustering algorithms, in general, has certain limitations. Traditional clustering techniques can face the problem of data sparseness in which the number of objects, or the number of links between heterogeneous objects, are too sparse to achieve effective clustering of objects. With homogenous clustering, the data set being analyzed contains the same type of objects. For example, if the homogenous clustering is based on a Web page and a user, then the Web page objects and the user objects will each be clustered separately. If the homogenous clustering is based on an item and a user, then the item objects and the user objects will each be clustered separately. In such homogenous clustering embodiments, those objects of the same type are clustered together without consideration of other types of objects.

Prior-art heterogeneous object clustering cluster the object sets separately. The heterogeneous object clustering uses the links only as flat features representing each object node. In prior art heterogeneous clustering, the overall link structure inside and between the layers is not considered, or alternatively simply treated as separated features

Exemplary Clustering Systems and Methods

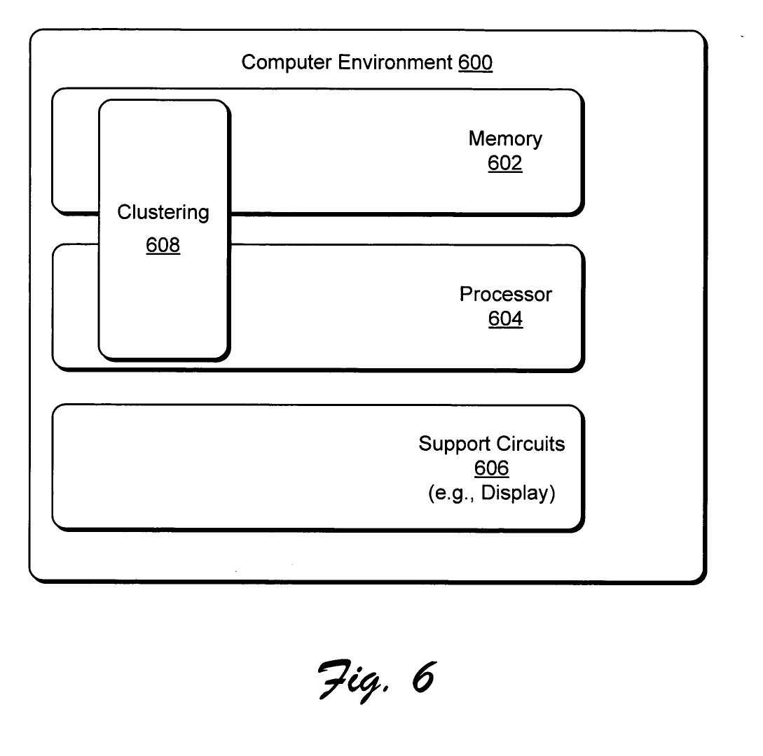

One embodiment of computer environment 600 (that is a general purpose computer) that can benefit by the use of clustering is shown in FIG. 6. The computer environment 600 includes a memory 602, a processor 604, a clustering portion 608, and support circuits 606. The support circuits include such devices as a display and an input/output circuit portion that allow the distinct components of the computer environment 600 to transfer information (i.e., data objects).

Clustering is performed within the clustering portion 608. The clustering portion 608 can be integrated within the memory 602 and the processor 604 portions of the computer environment. For example, the processor 604 processes the clustering algorithm (which is retrieved from memory) that clusters the different objects. The memory 602 (such as databases) is responsible for storing the clustered objects and the associated programs and clustering algorithms so that the clustered objects can be retrieved (and stored) as necessary. The computer environment 600 may be configured as a stand-alone computer, a networked computer system, a mainframe, or any of the variety of computer systems that are known. Certain embodiments disclosed herein describe a computer environment application (a computer downloading Web pages from the Internet). It is envisioned that the concepts described herein are applicable to any known type of computer environment 600.

This written description provides a clustering mechanism by which the percentage of the returned results that are considered reliable (i.e., are applicable to the user's query) is increased. Clustering can be applied to such technical areas as search tools, information mining, data mining, collaborative filtering, etc. Search tools have received attention because of their capabilities to serve different information needs and achieve improved retrieval performance. Search tools are associated with such computer aspects as Web pages, users, queries, etc.

The present written description describes a variety of clustering algorithm embodiments for clustering data objects. Clustering of data objects is a technique by which large sets of data objects are grouped into a larger number of sets or clusters of data objects (with each of the larger number of clusters of data objects having fewer data objects). Each data object contained within a clustered group of data objects has some similarity. One aspect of clustering therefore can be considered as grouping of multiple data objects.

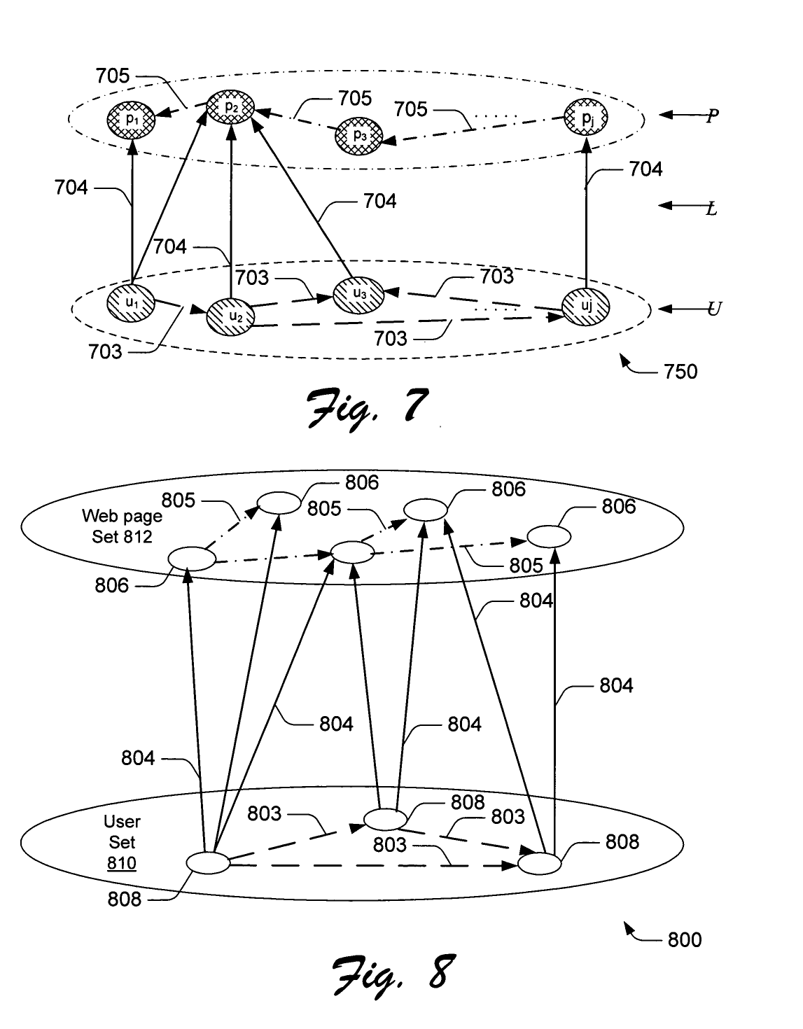

One clustering mechanism described in this written description relates to a framework graph 750, one embodiment of the framework graph is illustrated in FIG. 7. Certain embodiments of a unified clustering mechanism are provided in which different types of objects are clustered between different levels or node sets P and U as shown in the framework graph 750 of FIG. 7. It is also envisioned that the concepts described in this written description can be applied to three or more layers, instead of the two layers as described in the written description. Each node set P and U may also be considered a layer. In this written description, the term “unified” clustering applies to a technique for clustering heterogeneous data. The node set P includes a plurality of data objects p₁, p₂, p₃, . . . ,pᵢ that are each of a similar data type. The node set U includes a plurality of data objects u₁, u₂, u₃, . . . ,uⱼ that are each of a similar data type. The data type of the objects clustered on each node set (P or U) is identical, and therefore the data objects in each node set (P or U) are homogenous. The type of the data objects p₁, p₂, p₃, . . . ,pᵢ that are in the node set P are different from the types of the data objects u₁, u₂, u₃, . . . ,uⱼ that are in the node set U. As such, the types of data objects that are in different ones of the node sets P and U are different, or heterogeneous. Certain aspects of this written description provide for clustering using inputs (based on links) from homogenous and heterogeneous data types of objects.

Links are illustrated in this written description by lines extending between a pair of data objects. Links represent the relationships between pairs of data objects in clustering. In one instance, a link may extend from a Web page object to a user object, and represent the user selecting certain Web pages. In another instance, a link may extend from a Web page object to another Web page object, and represent relations between different Web pages. In certain embodiments of clustering, the “links” are referred to as “edges”. The generalized term “link” is used in this written description to describe links, edges, or any connector of one object to another object that describes a relationship between the objects.

There are a variety of different types of links (as described in this written description) that relate to clustering different types of objects that associate different ones of the objects as set forth in the framework graph 750. The links can be classified as either inter-layer link or intra-layer link. An intra-layer link 703 or 705 is one embodiment of link within the framework graph 750 that describes relationships between different objects of the same type. An inter-layer link 704 is one embodiment of link within the framework graph 750 that describes relationships between objects of different types. As shown in FIG. 7, there are a plurality of intra-layer links 703 extending between certain one of the data objects u₁, u₂, u₃, . . . ,uⱼ. In the embodiment shown in FIG. 7, there are also a plurality of intra-layer links 705 extending between certain ones of the data objects p₁, p₂, p₃, . . . ,pᵢ. In the embodiment shown in FIG. 7, there are also a plurality of inter-layer links 704 extending between certain ones of the data objects u₁, u₂, u₃, . . . ,uⱼ in the node set P and certain ones of the data objects p₁, p₂, p₃, . . . ,pᵢ in the node set U. Using inter-layer links recognizes that clustering of one type of object may be affected by another type of object. For instance, clustering of web page objects may be affected by user object configurations, state, and characteristics.

The link direction (as provided by the arrowheads for the links 703, 704, or 705 in FIG. 7, and also in FIG. 8) are illustrated as bi-directional since the relationships between the data objects may be directed in either direction. The links are considered illustrative and not limiting in scope. Certain links in the graph in the framework graph 750 may be more appropriately directed in one direction, the direction of the arrowhead typically does not affect the framework's operation. The framework graph 750 is composed of node set P, node set U, and link set L. With the framework graph 750, pᵢ and uⱼ represent two types of data objects, in which pᵢεP (i=1, . . . , I) and uⱼεU (j=1, . . . , J). I and J are cardinalities of the node sets P and U, respectively.

Links (pᵢ, uⱼ)εL are inter-layer links (which are configured as 2-tuples) that are illustrated by reference character 704 between different types of objects. Links (pᵢ, pⱼ)εL and (uᵢ, uⱼ)εL, that are referenced by 705 and 703, respectively, are intra-layer links that extend between the same type of object. For simplicity, different reference characters are applied for inter-layer link sets (204) and intra-layer link sets (503, 705).

Using unified clustering, links are more fully utilized among objects to improve clustering. The clustering of the different types of objects in the different layers is reinforced by effective clustering. If objects are clustered correctly then clustering results should be more reasonable. Clustering can provide structuralized information that is useful in analyzing data.

The framework graph 750 illustrates clustering of multiple types of objects in which each type of objects is substantially identical (e.g., one type pertains to a group of web pages, a group of users, or a group of documents, etc.). The type of each group of objects generally differs from the type of other groups of the objects within the framework graph 750.

The disclosed clustering technique considers and receives input from different (heterogeneous) object types when clustering. One aspect of this written description is based on an intrinsic mutual relation in which the objects being clustered is provided with links to other objects. Certain ones of the links (and the objects to which those links connect) that connect to each object can be weighted with different importance to reflect their relevance to that object. For example, objects of the same types as those being clustered can be provided with greater importance than objects of a different type. This written description provides a mechanism by which varying levels of importance can be assigned to different objects or different types of objects. This assigning of different levels of importance to different objects (or different types of objects) is referred to herein as clustering with importance. The varying levels of importance of the different objects often results in improved clustering results and effectiveness.

In the embodiment of the framework graph 750 for clustering heterogeneous objects as shown in FIG. 7, the different node sets P or U represent different layers each containing different object types. The multiple node sets (P and U are illustrated) of the framework graph 750 provide a basis for clustering. The two-layered directed graph 750 contains a set of data objects to be clustered. Objects of each type of object types (that are to be clustered according to the clustering algorithm) can be considered as the instance of a “latent” class. The links 703, 704, or 705 that extend between certain ones of the object nodes reflect inherent relations among the object nodes that are provided by the clustering. An iterative projecting technique for clustering, several embodiments of which are described in this written description, enables separate clustering of objects that have separate data types to contribute to the clustering process.

The heterogeneous types of objects (and their associated links) are reinforced by using the iterative clustering techniques as described herein. The iterative clustering projection technique relies on obtaining clustering information from separate types of objects that are arranged in separate layers, with each layer containing a homogenous type of object. The node information in combination with the link information is used to iteratively project and propagate the clustered results (the clustering algorithm is provided between layers) until the clustering converges. Iteratively clustering results of one type of object into the clustering results of another type of object can reduce clustering challenges associated with data sparseness. With this iterative projecting, the similarity measure in one layer clustering is calculated on clusters instead of individual groups of clusters of another type.

Each type of the different kinds of nodes and links are examined to obtain structural information that can be used for clustering. Structural information, for example, can be obtained considering the type of links connecting different data objects (e.g., whether a link is an inter-layer link or an intra-layer link). The type of each object is indicated by its node set P or U, as indicated in FIG. 7.

The generalized framework graph 750 of FIG. 7 can be applied to a particular clustering application. Namely, the framework graph 750 can illustrate a group of Web pages on the Internet relative to a group of users. The Web page layer is grouped as the node set P. The user layer of objects is grouped as the node set U. The framework graph 750 integrates the plurality of Web page objects and the plurality of user objects in the representation of the two-layer framework graph 750. The framework graph 750 uses link (e.g., edge) relations 703, 704, 705 to facilitate the clustering of the different type of objects (as outlined by the generalized FIG. 7 framework graph). The link structure of the whole data set is examined during the clustering procedure to learn the different importance level of nodes. The nodes are weighted based on their importance in the clustering procedure to ensure that important nodes are clustered more reasonably.

In certain embodiments of the present written description, the links 703, 704, and 705 among clusters in the links are reserved. Reserved links are those links that extend between clusters of objects instead of the objects themselves. For example, one reserved link extends between a web-page cluster and a user cluster (instead of between a web page object and a user object as with the original links). In certain embodiments, the reserved links are maintained for a variety of future applications, such as a recommendation in the framework graph 750. E.g., the clustering result of Web page/user clustering with reserved links could be shown as a summary graph of user hits behaviors, which provides the prediction of user's hits.

The content of the respective nodes pᵢ and uⱼ are denoted by the respective vectors fᵢ and gⱼ (not shown in FIG. 7). Depending on the application, each individual node pᵢ and uⱼ may have (or may not have any) content features. Prior-art clustering techniques cluster the nodes pᵢ independently from the nodes uⱼ. In contrast, in the clustering framework 750 described in this written description the nodes pᵢ and the nodes uⱼ are clustered dependently based on their relative importance. The clustering algorithm described herein uses a similarity function to measure distance between objects for each cluster type to produce the clustering. The cosine-similarity function as set forth in (1) can be used for clustering:

$$\begin{matrix}{s}_{c} ( x , y ) = cos ( {f}_{x} , {f}_{y} ) = \frac{{\sum }_{i = 1}^{kx} {f}_{x} ( i ) \cdot {\sum }_{i = 1}^{ky} {f}_{y} ( j )}{\sqrt{{\sum }_{i = 1}^{kx} {f}_{x}^{2} ( i )} \cdot \sqrt{{\sum }_{j = 1}^{ky} {f}_{y}^{2} ( j )}} & ( 1 ) \\ {s}_{c} ( x , y ) = cos ( {f}_{x} , {f}_{y} ) = \frac{{f}_{x} \cdot {f}_{y}}{‖ {f}_{x} ‖ ‖ {f}_{y} ‖} = \frac{{\sum }_{k , {f}_{x} ( k ) = {f}_{y} ( k )} {f}_{x} ( k ) {f}_{y} ( k )}{\sqrt{{\sum }_{i = 1}^{kx} {f}_{x}^{2} ( i )} \cdot \sqrt{{\sum }_{j = 1}^{ky} {f}_{y}^{2} ( j )}} & ( 2 )\end{matrix}$$

fₓ·f_{y} is the dot product of two feature vector. It equals to the sum of weight product of the same component in fx and fy. S_{c} denotes that the similarity is based on content feature; fₓ(i) and f_{y}(j) are ith and jth components of the feature vector fₓ and f_{y}. kx is the number of items in the respective feature fₓ; and ky is the number of items in the feature f_{y}.

In this written description, the node set P is used as an example to illustrate the inter-layer link 704 and the intra-layer links 703 and 705 of the nodes. All data is assumed to comprise a sequence of node pairs, for intra-layer node pairs (p⁽¹⁾, p⁽¹⁾), (p⁽²⁾, p⁽²⁾), . . . [where p⁽¹⁾ and p⁽²⁾ are the same as pᵢ, and the pairs (p⁽¹⁾, p⁽¹⁾), (p⁽²⁾, p⁽²⁾), both stands for a node in the homogeneous layer] such as connected by links 703 or 705; and for inter-layer pairs (p⁽¹⁾, u⁽¹⁾), (p⁽²⁾, u⁽²⁾), . . . such as connected by links 704. Thus a link between a pair of nodes (pᵢ, pₖ) or (pᵢ, uⱼ) represents one or more occurrence of identical pairs in the data series. The weight of the link relates to its occurrence frequency.

In this written description, two separate vectors represent features of the inter-layer links 704 and the intra-layer links 703, 705 for each particular node. For example, the intra-layer link 703, 705 features are represented using a vector whose components correspond to other nodes in the same layer. By comparison the inter-layer link 704 feature is represented using a vector whose components correspond to nodes in another layer. Each component could be a numeric value representing the weight of link from (or to) the corresponding node. For example, the inter-layer link 704 feature of nodes p₁ and p₂ (as shown in FIG. 7) can be represented as [1, 0, 0 . . . , 0]^{T} and [1, 1, 1, . . . , 0]^{T}, respectively.

Thus, the corresponding similarity function could be defined as cosine-similarity as above. The similarity function sₗₓ(x,y) for intra-layer link 703, 705 features determines the similarity between nodes p₁ and p₂ is applied is described in (3) as follows:

$${s}_{{l}_{1}} ( x , y ) = cos ( {l}_{x} , {l}_{y} ) = \frac{{l}_{x} \cdot {l}_{y}}{‖ {l}_{x} ‖ ‖ {l}_{y} ‖} \qquad ( 3 )$$

By comparison, the similarity function sₗₓ(x,y) for inter-layer link 704 features determines the similarity between nodes p₁ and u₂ in (4) as follows:
sₗ₂(x,y)=cos(hₓ, h_{y}) (4)
where sₗ₁ and sₗ₂ respectively denote that the similarities are based on respective intra-layer and inter-layer link features; lₓ and l_{y} are intra-layer link feature vectors of node x and node y; while hₓ and h_{y} are inter-layer link feature vectors of node x and node y.

Other representations of link features and other similarity measures could be used, such as representing links of each node as a set and applying a Jaccard coefficient. There are multiple advantages of the embodiments described herein. One advantage is that certain ones of the embodiments of clustering algorithms accommodate weighted links. Moreover, such clustering algorithms, as the k-means clustering algorithm, facilitate the calculation of the centroid of the clustering. The centroid is useful in further calculations to indicate a generalized value or characteristic of the clustered object.

The overall similarity function of node x and node y can be defined as the weighted sum of the three similarities including the three weighted values a, β, and γ as set forth in (5). There are two disclosed techniques to assign the three weighted values: heuristically and by training. If, for example, there is no tuning data, the weights are assigned manually to some desired value (e.g. alpha=0.5, beta=0.25, and gamma=0.25). If there is some extra tuning data, by comparison, then the weights can be calculated using a greedy algorithm, a hill-climbing algorithm, or some other type of either local or global improvement or optimizing program. A greedy algorithm refers to a type of optimization algorithm that seeks to improve each factor in each step, so that eventually an improved (and optimized in certain embodiments) solution can be reached.
s(x,y)=αs_{c}(x,y)+βsₗ₁(x,y)+γsₗ₂(x,y) (5)
where α+β+γ32 1.

Using these calculations, the content of the nodes, and the similarity of the nodes, are determined. Depending on the application, the three variables can be modified to provide different information values for the clustering algorithm. These contents and similarities of the nodes can thereupon be used as a basis for retrieval.

Many heterogeneous clustering problems often share the same property that the nodes are not equally important. Examples of heterogeneous clustering include Web page/user clustering, item/user clustering for collaborative filtering, etc. For these applications, important objects play an important role in getting more reasonable clustering results. In this written description, the link structure of the whole dataset is used to learn the importance of nodes. For each node in the node set P and U, for example pᵢ and uⱼ, importance weights ipᵢ, and iuⱼ are calculated by the link structure and are used in clustering procedure.

One clustering aspect relates a link analysis algorithm, multiple embodiments of which are provided in this written description. In one embodiment of the link analysis algorithm, a hybrid net model 800 as shown in FIG. 8 is constructed. Using the hybrid net model 800, the users and the Web pages are used as two illustrative types of nodes. The FIG. 8 embodiment of hybrid net model involving Web page and user types of objects is particularly directed to types of clustering involving the Internet, intranets, or other networks. The links include Web page hyperlinks/interactions as shown by link 805, user-to-Web page hyperlinks/interactions as shown by link 804, and user-to-user hyperlinks/interactions as shown by link 803. The hybrid net model 800 of FIG. 8 explicates these hyperlinks/relations by indicating the relations in and between users and Web pages that are illustrated by links 803, 804, and 805.

Given a certain group of users 808 that are contained within a user set 810, all Web pages that any of the nodes from the user set 810 have visited form the Web page set 812. The Web page set 812 is determined by sending the root Web page set to search engines and obtain a base Web page set. Three kinds of links represented by the arrows in FIG. 8 have different meanings. Those links represented by the arrows 805 that are contained within the Web page set 812 indicate hyperlinks between Web pages. Those links represented by arrows 803 that are contained within the user set 810 indicate social relations among users. Those links represented by arrows 804 that extend between the users set 810 and the Web page set 812 indicate the user's visiting actions toward Web pages. The links represented by arrows 804 indicate the user's evaluation of each particular Web page, so the authority/hub score of a Web page will be more credible. Since the different types of links 803, 804, and 805 represent different relations. Each link can be weighted with a different importance depending, for example, on how often the link is accessed or how each pair of nodes that are connected by the link are associated.

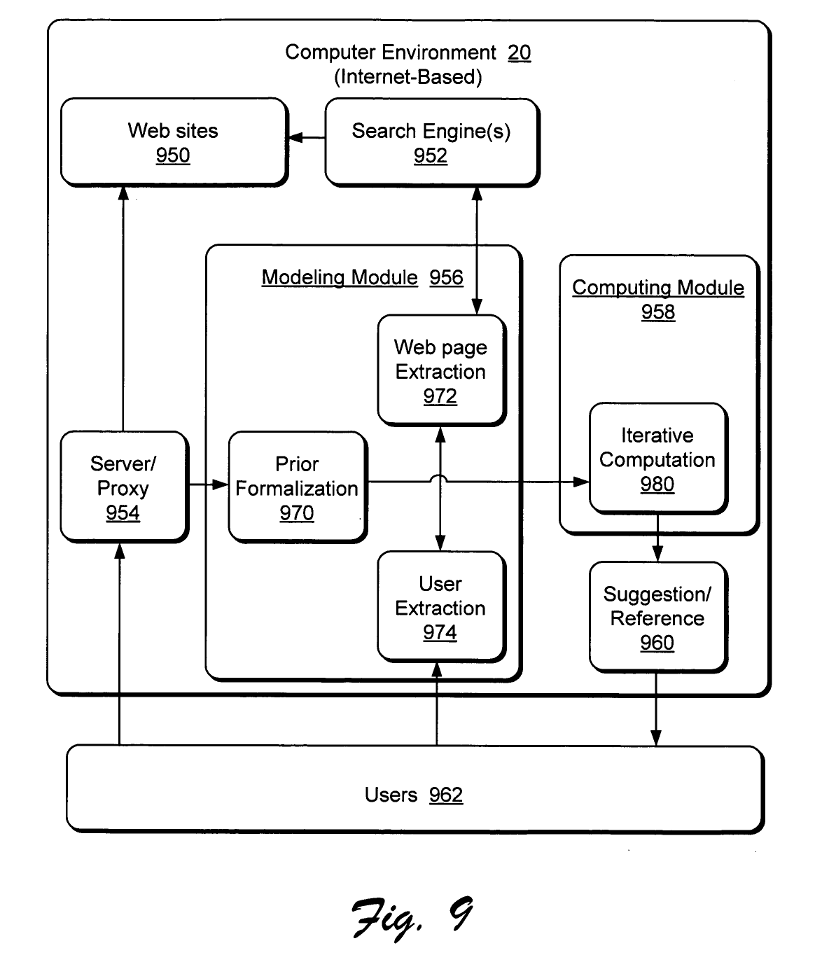

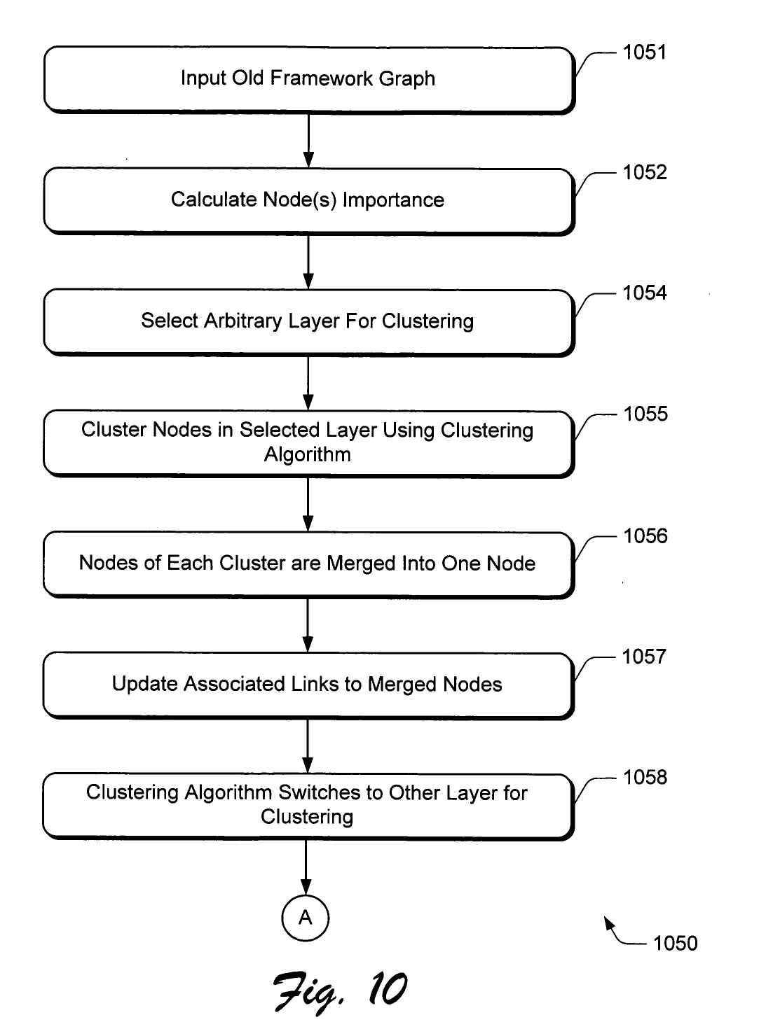

FIG. 9 illustrates one embodiment of the computer environment 600 that is configured to perform clustering using the Internet. One aspect of such clustering may involve clustering the Web pages based on users (including the associated inter-layer links and the intra-layer links). The computer environment includes a plurality of Web sites 950, a search engine 952, a server/proxy portion 954, a modeling module 956, a computing module 958, and a suggestion/reference portion 960. The computer environment 600 interfaces with the users 962 such as with a graphical user interface (GUI). The computing module 958 includes an iterative computation portion 980 that performs the clustering algorithm (certain embodiments of which rely on iterative computation). The modeling module 956 acts to collect data and track data (e.g., associated with the objects). The search engines return search results based on the user's query. The Web sites 950 represent the data as it is presented to the user. The server/proxy communicates the queries and the like to a server that performs much of the clustering. The suggestion/reference portion 960 allows the user to modify or select the clustering algorithm.

The modeling module 956 includes a prior formalization portion 970, a webpage extraction portion 972, and a user extraction portion 974. Portions 970, 972, and 974 are configured to provide and/or track data that has been previously formalized 970, is extracted from a Web page, or is extracted from the user 962. The embodiment of computer environment as illustrated in FIG. 9 is configured to provide a link analysis algorithm, one embodiment of which is described in this written description.

One embodiment of clustering algorithm can analyze a Web graph by looking for two types of pages: hubs, authorities, and users. Hubs are pages that link to a number of other pages that provide useful relevant information on a particular topic. Authority pages are considered as pages that are relevant to many hubs. Users access each one of authorities and hubs. Each pair of hubs, authorities, and users thereby exhibits a mutually reinforcing relationship. The clustering algorithm relies on three vectors that are used in certain embodiments of the present link analysis algorithm: the web page authority weight vector a, the hub weight vector h, and the user vector u. Certain aspects of these vectors are described in this written description.

Several of the following terms relating to the following weight calculations are not illustrated in the figures such as FIG. 9, and instead relate to the calculations. In one embodiment, for a given user i, the user weight uᵢ denotes his/her knowledge level. For a Web page j, respective terms aⱼ and hⱼ indicate the authority weight and the hub weight. In one embodiment, each one of the three vectors (representing the user weight u, the web page authority weight a, and the hub weight h) are each respectively initialized at some value (such as 1). All three vectors h, a, and u are then iteratively updated based on the Internet usage considering the following calculations as set forth respectively in (6), (7), and (8):

$$\{ \begin{matrix}a ( p ) = {\sum }_{q -> p} h ( q ) + {\sum }_{r -> p} u ( r ) & ( 6 ) \\ h ( p ) = {\sum }_{p -> q} a ( q ) + {\sum }_{r -> p} u ( r ) & ( 7 ) \\ u ( r ) = {\sum }_{r -> p} a ( p ) + {\sum }_{r -> q} h ( q ) & ( 8 )\end{matrix}$$

where, p and q stand for specific web-pages, and r stands for a specific user. There are two kinds of links in certain embodiments of the disclosed network: the links between different pages (hyperlinks) and the links between users and pages (browsing patterns). Let A=[aᵢⱼ] denote the adjacent matrix of the base set for all three vectors h, a, and u. Note that aᵢⱼ=1 if page i links to page j, or alternatively aᵢⱼ=0. V=[vᵢⱼ] is the visit matrix of the user set to Web page set. Consider that vᵢⱼ=1 if user i visit page j, or alternatively vᵢⱼ=0. Also, as set forth in (8), (10), and (11):

$$\{ \begin{matrix}a = {A}^{T} h + {V}^{T} u & ( 9 ) \\ h = Aa + {V}^{T} u & ( 10 ) \\ u = V ( a + h ) & ( 11 )\end{matrix}$$

In one embodiment, the calculation for vectors a, h, u as set forth in (9), (10), and (11) go through several iterations to provide meaningful results. Prior to the iterations in certain embodiments, a random value is assigned to each one of the vectors a, h, and u. Following each iteration, the values of a, h, u will be changed and normalized to provide a basis for the next iteration. Following each iteration, the iterative values of a, h, and u each tend to converge to a certain respective value. The users with high user weight uᵢ and Web pages with high authority weight aⱼ and/or hub weight hⱼ can be reported. In a preferred embodiment, certain respective user or web-page objects can be assigned with higher values than other respective user or web-page objects. The higher the value is, the more importance is assigned to that object.

The embodiment of link analysis algorithm as described in this written description that can cluster thereby relies on iterative input from both Web pages and users. As such, weighted input from the user is applied to the clustering algorithm of the Web page. Using the weighted user input for the clustering improves the precision of the search results, and the speed at which the clustering algorithm can be performed.

While the link analysis algorithm described herein is applied to clustering algorithms for clustering Web pages based on users, it is envisioned that the link analysis algorithm can be applied to any heterogeneous clustering algorithm. This weighting partially provides for the clustering with importance as described herein.

A variety of embodiments of a clustering algorithm that can be used to cluster object types are described. Clustering algorithms attempt to find natural groups of data objects based on some similarity between the data objects to be clustered. As such, clustering algorithms perform a clustering action on the data objects. Certain embodiments of clustering algorithm also finds the centroid of a group of data sets, which represents a point whose parameter values are the mean of the parameter values of all the points in the clusters. To determine cluster membership, most clustering algorithms evaluate the distance between a point and the cluster centroid. The output from a clustering algorithm is basically a statistical description of the cluster centroids with the number of components in each cluster.

Multiple embodiments of cluster algorithms are described in this written description. The two-ways k-means cluster algorithm is based on the mutual reinforcement of clustering process. The two-ways k-means cluster algorithm is an iterative clustering algorithm. In the two-ways k-means cluster algorithm, the object importance is first calculated by (6)-(8) or (9)-(11), and the result is then applied in the followed iterative clustering procedure. The clustering algorithm clusters objects in each layer based on the defined similarity function. Although a great deal of clustering algorithms, such as k-means, k-medoids, and agglomerative hierarchical methods could be used, this written description describes the application of the k-means clustering algorithm.

There are several techniques to apply the calculated importance score of nodes. One technique involves modifying the basic k-means clustering algorithm to a ‘weighted’ k-means algorithm. In the modified k-means algorithm, the centroid of the given cluster is calculated using the weighted sum of the features with the weight setting determining the importance score. The nodes having a higher importance or weighting are thereby given more emphasis in forming the cluster centroid for both the content and the link features. Another embodiment involves modifying the nodes' link weight by their importance score, and then using the weighted link feature in the similarity function. In this way, the importance of the nodes is only reflected in the link feature in clustering process.

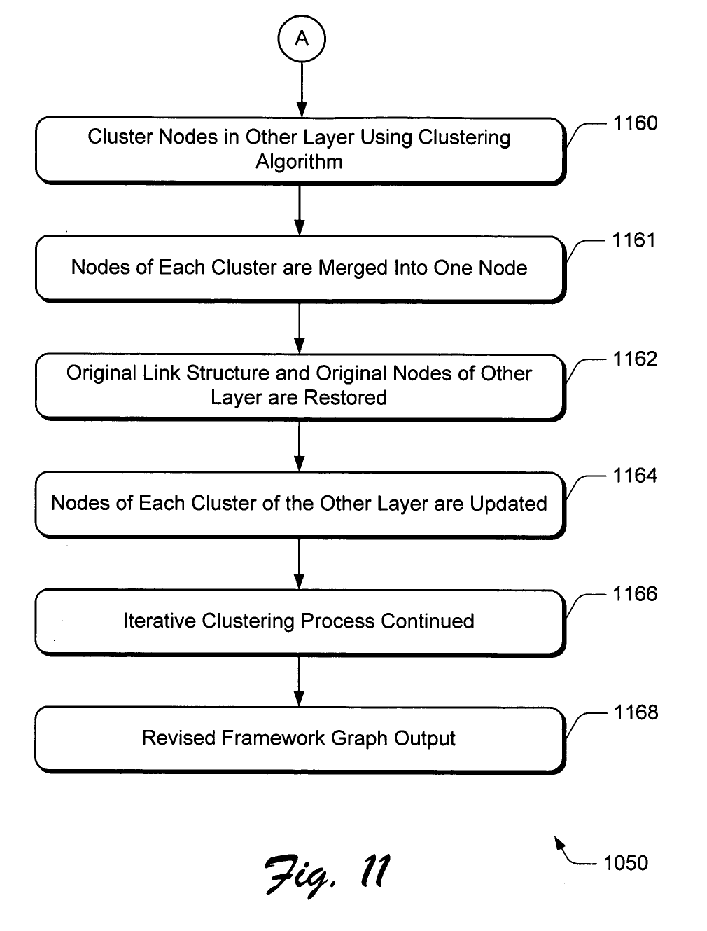

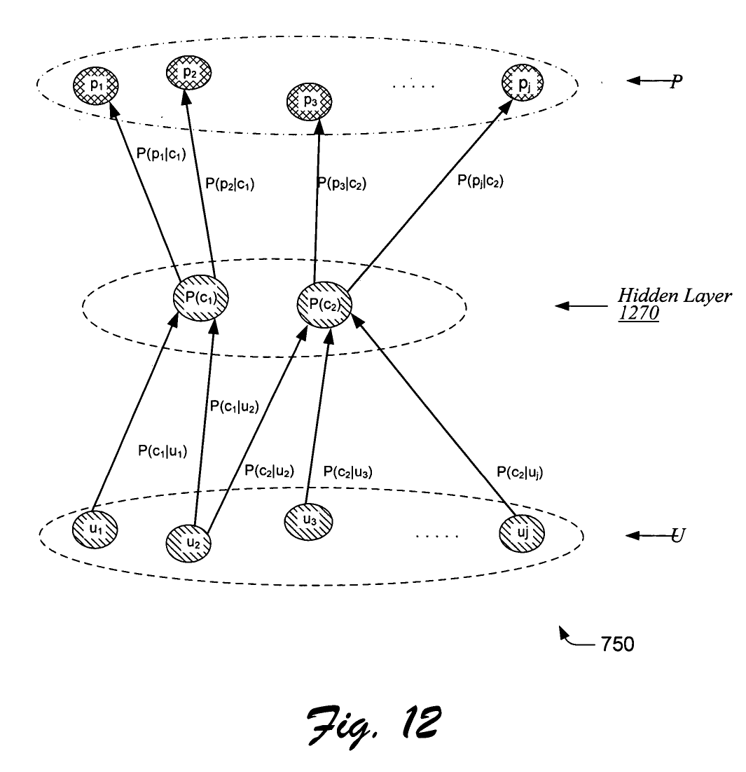

One embodiment of the input/output of the clustering algorithm is shown in FIGS. 10 and 11. The input to the clustering algorithm includes a two-layered framework graph 750 (including the content features fᵢ and gⱼ of the nodes). The output to the clustering algorithm includes a new framework graph 750 that reflects the clustering. In certain embodiments of the new framework graph, the variations of each old node that has changed into its new node position can be illustrated.

One embodiment of a flow chart illustrating one embodiment of the clustering algorithm 1050 is shown in FIGS. 10 and 11. The clustering algorithm 1050 includes 1051 in which the original framework graph (prior to each clustering iteration) is input. In 1052, the importance of each node being considered is determined or calculated using (6)-(8) or (9)-(11). In 1054, an arbitrary layer is selected for clustering. Nodes in the selected layer are clustered in an appropriate fashion (e.g., according to content features) in 1055. In certain embodiments, the nodes can be filtered using a desired filtering algorithm (not shown) to improve the clustering. In 1056, the nodes of each cluster are merged into one node. For instance, if two candidate nodes exist following the filtering, the closest two candidate nodes can be merged by, e.g., averaging the vector values of the two candidate nodes. This merging allows individual nodes to be combined to reduce the number of nodes that have to be considered. As such, the merging operation can be used to reduce the occurrence of duplicates and near-duplicates.

The corresponding links are updated based on the merging in 1057. In 1058, the clustering algorithm switches to a second layer (from the arbitrarily selected layer) for clustering. In 1160, the nodes of the second layer are clustered according to their content features and updated link features. In 1161, the nodes of each cluster are merged into one node.

In 1162, the original link structure and the original nodes of the other layer are restored. In 1164, the nodes of each cluster of the second layer are merged, and the corresponding links are updated. In 1166, this iterative clustering process is continued within the computer environment. In 1168, a revised version of the framework graph 750 is output.

In the initial clustering pass, only the content features are utilized. Because in most cases the link feature are too sparse in the beginning to be useful for clustering. In subsequent clustering passes, content features and link features are combined to enhance the effectiveness of the clustering. By combining the content features and the link features, the weights are specified with different values and the results can be compared, and clustering having an improved accuracy can be provided.

The clustering algorithm as described relative to FIGS. 10 and 11 can be applied to many clustering embodiments. More particularly, one embodiment of clustering of Web pages based on how the Web pages are accessed by users is now described. In those types of link extends between a node of the user layer to a node of the Web page layer, a user uⱼ has visited a Web page pᵢ before if there is one link from uⱼ to pᵢ. The weight of the link means the probability that the user uⱼ will visit the page pᵢ at a specific time, denoted as Pr(pᵢ|uⱼ). It can be simply calculated by counting the numbers within the observed data, as shown in (12).

$$Pr ( {p}_{i} \vert {u}_{j} ) = \frac{C ( {p}_{i} , {u}_{j} )}{{\sum }_{t ∈ P ( {u}_{j} )} C ( {p}_{t} , {u}_{j} )} \qquad ( 12 )$$

where, P(uⱼ) is the set of pages that visited by the user uⱼ before. C(pᵢ,uⱼ) stands for the count that the user uⱼ have visited page pᵢ before.

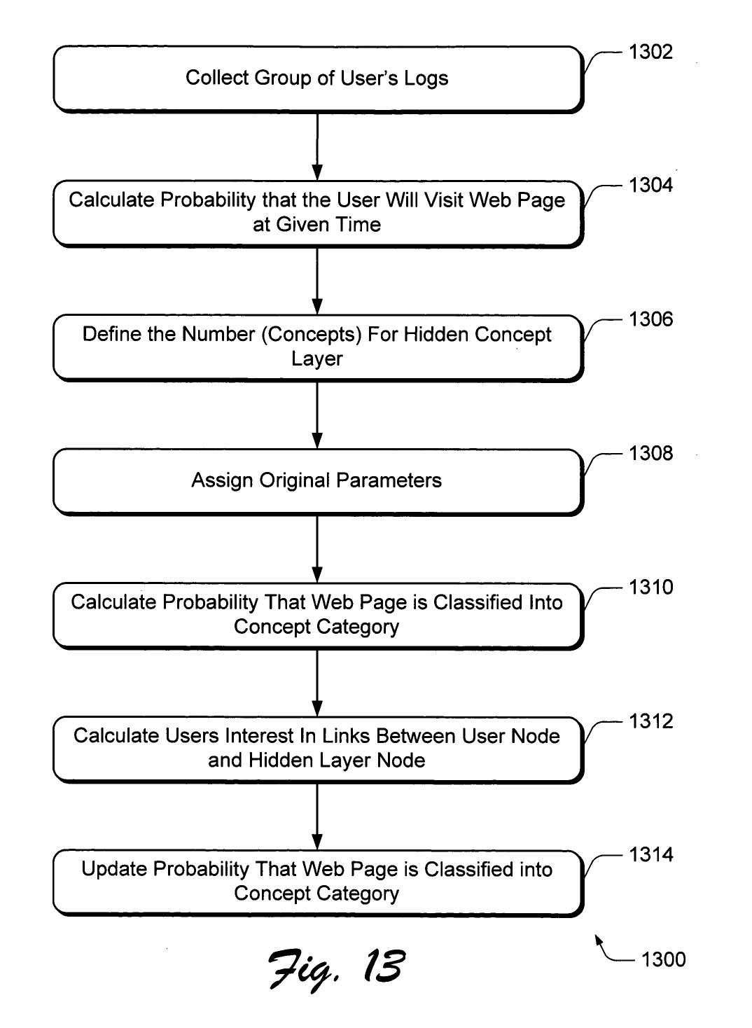

One embodiment of clustering algorithm, as shown in the embodiment of framework graph 750 of FIG. 12, involves a concept layer or hidden layer. In FIG. 12, for simplicity, the intra-layer link 703 and 705 that are shown in the framework graph of FIG. 7 are hidden. It is envisioned, however, that the embodiment of framework graph 750 as shown in FIG. 12 can rely on any combination of intra-layer links and inter-layer links and still remain within the concepts of the present written description.

The hidden layer 1270 (in the embodiment of framework graph 750 as displayed in FIG. 12) lies between web-page layer and user layer. The hidden layer 750 provides an additional layer of abstraction (from which links extend to each of the node sets P and U) that permit modeling with improved realism compared to extending links between the original node sets P and U. One of the inter-layer links 704 of the embodiment of framework graph 750 such as shown in FIG. 7 (that does not have a hidden layer) may be modeled as a pair of hidden inter-layer links of the embodiment of framework graph 750 such as shown in FIG. 12. One of the hidden inter-layer links extends between the web-page layer containing the node set P and the hidden layer 1270, and one of the hidden inter-layer links extends between the user layer and the hidden layer 1270. The direction of the arrows on each hidden inter-layer link shown in FIG. 12 is arbitrary, as is the particular web pages and users in the respective node sets P and U that are connected by a hidden inter-layer link to a node in the hidden layer.

Links (i.e., hidden inter-layer links) that extend between the web-page layer containing the node set P and the hidden layer 1270 indicate how likely a web-page p₁, p₂, etc. belongs to a particular concept node P(c₁), P(c₂), etc. in the hidden layer 1270. Links (i.e., hidden inter-layer links) that extend between the user layer and the hidden layer 1270 indicate how likely a user node u₁, u₂, etc. has interest in a particular concept node P(c₁), P(c₂), etc. within the hidden layer 1270.

The links that extend between the web-page layer and the concept layer therefore each stand for the probability that a Web page pᵢ is classified into a concept category cₖ, denoted as Pr(pᵢ|cₖ). This model embodied by the framework graph shares the assumption used by Naïve Bayesian classification, in which different words are considered conditionally independent. So the concept cₖ can be represented as a normal distribution, i.e. a vector \vec{μ}ₖ for expectation and a \vec{σ}ₖ vector for covariance. The value Pr(pᵢ|cₖ) can be derived as per (13).

$$E ( Pr ( {p}_{i} \vert {c}_{k} ) ) = \frac{Pr ( {p}_{i} \vert {c}_{k} )}{{\sum }_{t} Pr ( {p}_{t} \vert {c}_{k} )} = \frac{{\prod }_{l} Pr ( {w}_{l , i} \vert {c}_{k} )}{{\sum }_{t} {\prod }_{l} Pr ( {w}_{l , t} \vert {c}_{k} )} \\ = \frac{{ⅇ}^{- {\sum }_{l} \frac{1}{2 {σ}_{l , k}} {( {w}_{l , i} - {μ}_{l , k} )}^{2}}}{{\sum }_{t} {ⅇ}^{- {\sum }_{l} \frac{1}{2 {σ}_{l , k}} {( {w}_{l , k} - {μ}_{l , k} )}^{2}}} , \qquad ( 13 )$$

where w_{l,i} is the weight of web page pᵢ on the lth word.

Those links (denoted as Pr(cₖ|uⱼ)) that extend between a node in the user layer and a node in the hidden layer reflect the interest of the user in the category reflected by the concept. Thus, one vector (Iⱼ₁, Iⱼ₂, . . . Iⱼₙ) Iⱼₖ=Pr(cₖ|uⱼ) corresponds to each user, in which n is the number of the hidden concept. The links shown in FIG. 12 can be considered as the vector models of the user. The vector is constrained by the user's usage data as set forth in (14).

$$Pr ( {p}_{i} \vert {u}_{j} ) = {\sum }_{l} Pr ( {p}_{i} \vert {c}_{l} , {u}_{j} ) Pr ( {c}_{l} \vert {u}_{j} ) \approx {\sum }_{l} Pr ( {p}_{i} \vert {c}_{l} ) Pr ( {c}_{l} \vert {u}_{j} ) \qquad ( 14 )$$

Thus, the value Pr(cₖ|uⱼ) can be obtained by finding the solution from (13).

To simplify, Pr(pᵢ|uⱼ)=R_{i,j}, Pr(pᵢ|cₖ)=S_{i,k}, and Pr(cₖ|uⱼ)=T_{k,j}. The user j can be considered separately as set forth in (15).

$$[ \begin{matrix}{R}_{1 , j} \\ {R}_{2 , j} \\ ⋯ \\ {R}_{\vert Page \vert , j}\end{matrix} ] = [ \begin{matrix}{S}_{1 , 1} & {S}_{1 , 2} & ⋯ & {S}_{1 , \vert Concept \vert} \\ {S}_{2 , 1} & {S}_{2 , 2} & & \\ & & ⋯ & \\ {S}_{\vert Page \vert , 1} & & ⋯ & {S}_{\vert Page \vert , \vert Concept \vert}\end{matrix} ] \times [ \begin{matrix}{T}_{1 , j} \\ {T}_{2 , j} \\ ⋯ \\ {T}_{\vert Concept \vert , j}\end{matrix} ] \qquad ( 15 )$$

where “|Page|” is the total number of the Web pages, and “|Concept|” is the total number of the hidden concept. Since |Page|>>|Concept|, a least square solution of T_{k,j} can be solved using (15), or alternatively (16).

$$\begin{matrix}[ {R}_{i , 1} & {R}_{i , 2} & ⋯ & {R}_{i , \vert User \vert} ] =\end{matrix} \begin{matrix}[ {S}_{i , 1} & {S}_{i , 2} & ⋯ & {S}_{i , \vert Concept \vert} ] \times \end{matrix} [ \begin{matrix}{T}_{1 , 1} & {T}_{1 , 2} & ⋯ & {{T}_{1}}_{, \vert User \vert} \\ {T}_{2 , 1} & {T}_{2 , 2} & & \\ ⋯ & & ⋯ & \\ {T}_{\vert Concept \vert , 1} & & & {T}_{\vert Concept \vert , \vert User \vert}\end{matrix} ] \qquad ( 16 )$$

where “|User|” is the total number of the users.

Since |User|>>|Concept|, we can also give a least square solution of S_{i,k} as set forth in (17).

$${{μ}^{->}}_{j} = {\sum }_{t} {{P}^{->}}_{t} Pr ( {p}_{t} \vert {c}_{k} ) = {\sum }_{k} {S}_{t , k} {{P}^{->}}_{t} \qquad ( 17 )$$

After the vector for expectation \vec{μ}ⱼ is obtained, a new vector for covariance \vec{σ}ⱼ can be calculated. While the embodiment of framework graph 750 that is illustrated in FIG. 12 extends between the node set P and the node set U, it is envisioned that the particular contents of the node sets are illustrative in nature, and can be applied to any set of node sets.

One embodiment of the clustering algorithm in which Web page objects are clustered based on user objects can be outlined as follows as described relative to one embodiment of Web page clustering algorithm shown as 1300 in FIG. 13:
1. Collect a group of users' logs as shown in 1302.
2. Calculate the probability of the user úⱼ; will visit the Web page pᵢ at a specific time Pr(pᵢ|uⱼ) as set forth by (12), and 1304 in FIG. 13.
3. Define the number |Concept| of nodes for the hidden concept layer (670 as shown in FIG. 12) in 1306 of FIG. 13, and randomly assign the initial parameters for the vector for expectation \vec{μ}ₖ and the initial vector for covariance \vec{σ}ₖ in 1308 of FIG. 13.
4. Calculate a Pr(pᵢ|cₖ) value, which represents the probability that a Web page pᵢ is classified into a concept category cₖ, as set forth in (13) and 1310 in FIG. 13.
5. Calculate Pr(cₖ|uⱼ), which represents the users interest in the links between a user node and a hidden layer node, which can be derived by (15) as shown in 1312 in FIG. 13.
6. Update the Pr(pᵢ|cₖ) probability that a Web page is classified into a concept category as determined in the outline step 6 by solving (13) as shown in 1314 of FIG. 13.
7. Re-estimate the parameters for each hidden concept node by using Pr(pᵢ|cₖ) as set forth in (13).
8. Go through (13) and (15) for several iterations to provide some basis for the values of the node sets (or at least until the model displays stable node set vector results).

1. A method comprising:
converting, by a computing device, unstructured service requests to one or more structured answer objects, each structured answer object comprising hierarchically structured historic problem diagnosis data; and
in view of a product problem description:
identifying a set of the one or more structured answer data objects, each structured solution data object in the set comprising term(s) and/or phrase(s) related to the product problem description; and
providing historic and hierarchically structured problem diagnosis data from the set to an end-user for product problem diagnosis.

2. A method as recited in claim 1, and wherein the problem diagnosis data comprise any one or more of a product problem description, symptom, cause, and resolution.

3. A method as recited in claim 1, and wherein the problem diagnosis data comprise a link to a product support article.

4. A method as recited in claim 1, and wherein converting, identifying, and providing are performed by a server computing device, and wherein the method further comprises:
receiving, from a client computing device, the product problem description; and
wherein providing further comprises:
searching an index for terms and/or phrases that match term(s) in the product problem description to identify the one or more structured answer objects in the set;
communicating the set to the client computing device for display by a troubleshooting wizard to the end-user.

5. A method as recited in claim 1, wherein the method further comprises dynamically generating a knowledge base article from information provided by the set.

6. A method as recited in claim 1, wherein after converting and before identifying and providing, the method further comprises:
generating an index by:
extracting features from the structured answer objects;
analyzing the features to identify the terms and the phrases;
assigning relevance weight to the terms and the phrases;
normalizing terminology within the terms and the phrases; and
wherein identifying is based on information in the index.

7. A method as recited in claim 6, wherein after converting and before identifying and providing, the method further comprises:
clustering respective ones of the structured answer objects based on the index to group related structured answer objects; and
wherein providing, if there is more that one structured answer object in the set, the set comprises a reinforced cluster of structured answer objects.

8. A method as recited in claim 7, wherein clustering comprises reinforced and unified clustering operations.

9. A method comprising:
communicating a search request to a server computing device, the search request comprising a product problem description;
responsive to receiving a response to the search request, presenting, by a troubleshooting wizard, information from the response; and
wherein the information comprises hierarchically structured historic problem diagnosis data, the historic problem diagnosis data being associated with term(s) and/or phrase(s) related to the product problem description.

10. A method as recited in claim 9, wherein the historic problem diagnosis data comprise any one or more of hierarchically structured product problem description, symptom, cause, and resolution information.

11. A method as recited in claim 9, wherein the information comprises a link to a product support article.

12. A method as recited in claim 9, wherein the information comprises a set of structured answer objects.

13. A method as recited in claim 12, wherein respective ones of the structured answer objects are clustered by the server as corresponding to one another, the clustering being based on reinforced clustering operations.

14. A method as recited in claim 13, wherein the clustering is further based on unified clustering operations.

15. A computer-readable media comprising computer-executable instructions for:
converting, by a computing device, unstructured service requests to one or more structured answer objects, each structured answer object comprising hierarchically structured historic problem diagnosis data; and
in view of a product problem description:
identifying a set of the one or more structured answer data objects, each structured solution data object in the set comprising term(s) and/or phrase(s) related to the product problem description; and
providing historic and hierarchically structured problem diagnosis data from the set to an end-user for product problem diagnosis.

16. A computer-readable media as recited in claim 15, and wherein the problem diagnosis data comprise any one or more of a product problem description, symptom, cause, and resolution.

17. A computer-readable media as recited in claim 15, and wherein the problem diagnosis data comprise a link to a product support article.

18. A computer-readable media as recited in claim 15, and wherein converting, identifying, and providing are performed by a server computing device, and wherein the computer-executable instruction further comprise instructions for:
receiving, from a client computing device, the product problem description; and
wherein providing further comprises:
searching an index for terms and/or phrases that match term(s) in the product problem description to identify the one or more structured answer objects in the set;
communicating the set to the client computing device for display by a troubleshooting wizard to the end-user.

19. A computer-readable media as recited in claim 15, wherein the computer-executable instruction further comprise instructions for dynamically generating a knowledge base article from information provided by the set.

20. A computer-readable media as recited in claim 15, wherein after converting and before identifying and providing, the computer-executable instruction further comprise instructions for:
generating an index by:
extracting features from the structured answer objects;
analyzing the features to identify the terms and the phrases;
assigning relevance weight to the terms and the phrases;
normalizing terminology within the terms and the phrases; and
wherein identifying is based on information in the index.

21. A computer-readable media as recited in claim 20, wherein after converting and before identifying and providing, the computer-executable instruction further comprise instructions for:
clustering respective ones of the structured answer objects based on the index to group related structured answer objects; and
wherein providing, if there is more that one structured answer object in the set, the set comprises a reinforced cluster of structured answer objects.

22. A computer-readable media as recited in claim 21, wherein clustering comprises reinforced and unified clustering operations.

23. A computer-readable media comprising computer-executable instructions for:
communicating a search request to a server computing device, the search request comprising a product problem description;
responsive to receiving a response to the search request, presenting, by a troubleshooting wizard, information from the response, the information comprising hierarchically structured historic problem diagnosis data, the historic problem diagnosis data being associated with term(s) and/or phrase(s) related to the product problem description.

24. A computer-readable media as recited in claim 23, wherein the historic problem diagnosis data comprise any one or more of hierarchically structured product problem description, symptom, cause, and resolution information.

25. A computer-readable media as recited in claim 23, wherein the information comprises a link to a product support article.

26. A computer-readable media as recited in claim 23, wherein the information comprises a set of structured answer objects.

27. A computer-readable media as recited in claim 26, wherein respective ones of the structured answer objects were clustered by the server as corresponding to one-another, the clustering being based on reinforced clustering operations.

28. A computer-readable media as recited in claim 27, wherein the clustering is further based on unified clustering operations.

29. A computer-readable media comprising a structured solution request data structure for use in product problem analysis and diagonsis, the structured solution request data structure comprising:
a product problem description data field;
a product problem cause data field;
a product problem resolution data field; and
wherein the product problem description data field is a parent node of the product problem cause data field, and the product problem cause data field is a parent node of the product problem resolution data field.

30. A computer-readable media as recited in claim 29, wherein the structured solution request data structure further comprises a product problem symptom data field, the product problem description field being a parent node of the product problem symptom data field.

31. A computing device comprising:
a processor; and
a memory coupled to the processor, the memory comprising computer-program instructions executable by the processor for:
converting, by a computing device, unstructured service requests to one or more structured answer objects, each structured answer object comprising hierarchically structured historic problem diagnosis data; and
in view of a product problem description:
identifying a set of the one or more structured answer data objects, each structured solution data object in the set comprising term(s) and/or phrase(s) related to the product problem description; and
providing historic and hierarchically structured problem diagnosis data from the set to an end-user for product problem diagnosis.

32. A computing device as recited in claim 31, and wherein the problem diagnosis data comprise any one or more of a product problem description, symptom, cause, and resolution.

33. A computing device as recited in claim 31, and wherein the problem diagnosis data comprise a link to a product support article.

34. A computing device as recited in claim 31, and wherein converting, identifying, and providing are performed by a server computing device, and wherein the computer-executable instruction further comprise instructions for:
receiving, from a client computing device, the product problem description; and
wherein providing further comprises:
searching an index for terms and/or phrases that match term(s) in the product problem description to identify the one or more structured answer objects in the set;
communicating the set to the client computing device for display by a troubleshooting wizard to the end-user.

35. A computing device as recited in claim 31, wherein the computer-executable instruction further comprise instructions for dynamically generating a knowledge base article from information provided by the set.

36. A computing device as recited in claim 31, wherein after converting and before identifying and providing, the computer-executable instruction further comprise instructions for:
generating an index by:
extracting features from the structured answer objects;
analyzing the features to identify the terms and the phrases;
assigning relevance weight to the terms and the phrases;
normalizing terminology within the terms and the phrases; and
wherein identifying is based on information in the index.

37. A computing device as recited in claim 36, wherein after converting and before identifying and providing, the computer-executable instruction further comprise instructions for:
clustering respective ones of the structured answer objects based on the index to group related structured answer objects; and
wherein providing, if there is more that one structured answer object in the set, the set comprises a reinforced cluster of structured answer objects.

38. A computing device as recited in claim 37, wherein clustering comprises reinforced and unified clustering operations.

39. A computing device comprising:
a processor; and
a memory coupled to the processor, the memory comprising computer-program instructions executable by the processor for:
communicating a search request to a server computing device, the search request comprising a product problem description;
responsive to receiving a response to the search request, presenting, by a troubleshooting wizard, information from the response, the information comprising hierarchically structured historic problem diagnosis data, the historic problem diagnosis data being associated with term(s) and/or phrase(s) related to the product problem description.

40. A computing device as recited in claim 39, wherein the historic problem diagnosis data comprise any one or more of hierarchically structured product problem description, symptom, cause, and resolution information.

41. A computer-readable media as recited in claim 39, wherein the information comprises a link to a product support article.

42. A computer-readable media as recited in claim 39, wherein the information comprises a set of structured answer objects.

43. A computer-readable media as recited in claim 42, wherein respective ones of the structured answer objects were clustered by the server as corresponding to one-another, the clustering being based on reinforced clustering operations.

44. A computer-readable media as recited in claim 43, wherein the clustering is further based on unified clustering operations.

45. A computing device comprising:
means for converting unstructured service requests to one or more structured answer objects, each structured answer object comprising hierarchically structured historic problem diagnosis data; and
in view of a product problem description:
means for identifying a set of the one or more structured answer data objects, each structured solution data object in the set comprising term(s) and/or phrase(s) related to the product problem description; and
means for providing historic and hierarchically structured problem diagnosis data from the set to an end-user for product problem diagnosis.

46. A computing device as recited in claim 45, and wherein the problem diagnosis data comprise any one or more of a product problem description, symptom, cause, and resolution.

47. A computing device as recited in claim 45, and wherein the problem diagnosis data comprise a link to a product support article.

48. A computing device as recited in claim 45, and further comprising:
means for receiving, from a client computing device, the product problem description; and
wherein the means for providing further comprises:
means for searching an index for terms and/or phrases that match term(s) in the product problem description to identify the one or more structured answer objects in the set; and
means for communicating the set to the client computing device for display by a troubleshooting wizard to the end-user.

49. A computing device as recited in claim 45, further comprising means for dynamically generating a knowledge base article from information provided by the set.

50. A computing device comprising:
means for communicating a search request to a server computing device, the search request comprising a product problem description;
responsive to receiving a response to the search request, means for presenting information from the response, the information comprising hierarchically structured historic problem diagnosis data, the historic problem diagnosis data being associated with term(s) and/or phrase(s) related to the product problem description.

51. A computing device as recited in claim 50, wherein the historic problem diagnosis data comprise any one or more of hierarchically structured product problem description, symptom, cause, and resolution information.

52. A computer-readable media as recited in claim 50, wherein the information comprises a link to a product support article.

53. A computer-readable media as recited in claim 50, wherein the information comprises a set of structured answer objects.

54. A computer-readable media as recited in claim 53, wherein respective ones of the structured answer objects were clustered by the server as corresponding to one another.
